(19) United States
(12) Patent Application Publication
(10) Pub. No.: US 2010/0098052 A1
(43) Pub. Date: Apr. 22, 2010

(54) RADIO COMMUNICATION SYSTEM AND RADIO BASE STATION APPARATUS

(75) Inventor: Muneyuki SUZUKI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, TOKYO (JP)

(21) Appl. No.: 12/555,363

(22) Filed: Sep. 8, 2009

(30) Foreign Application Priority Data
Oct. 21, 2008 (JP) 2008-270936

(51) Int. Cl. H04W 4/00; H04J 3/06

(52) U.S. Cl. 370/350; 455/561

(57) ABSTRACT

A radio communication system and a radio base station apparatus which are capable of high-speed transmission and the network synchronization using a metallic subscriber line are provided. The radio communication system has a plurality of radio base station apparatus CS which accommodates a radio terminal PS, a communication apparatus 1 which is connected to a IP network 4, and a digital subscriber line L3 which connects the radio base station apparatus CS and the communication apparatus. The radio base station apparatus CS has a clock unit which generates a clock of predetermined frequency common to each radio base station apparatus CS based on a signal supplied from the communication apparatus 1 via the digital subscriber line L3. The radio base station apparatus CS communicates the data with the radio terminal PS using a radio frame of a time division created based on the clock which the clock unit generates.

### CROSS REFERENCE TO RELATED APPLICATION

This application is based upon and claims the benefit of priority from the Japanese Patent Application No. 2008-270936, filed on Oct. 21, 2008, the entire contents of which are incorporated herein by reference.

### FIELD OF THE INVENTION

The invention relates to a radio communication system in which a radio terminal communicates with a communication partner via a radio base station apparatus and the radio base station apparatus used for the radio communication system.

### DESCRIPTION OF THE BACKGROUND

By advancement of the information and communication technology, a subscriber line which is an information transmission line has spread through enterprises, stores, and houses as an infrastructure for Internet access. Conventionally, a digital transmission system using a metallic subscriber line uses an ISDN (Integrated Services Digital Network) basic rate interface or an ADSL (Asymmetric Digital Subscriber Line) which is one of a DSL (Digital Subscriber Line) technology. In recent years, an optical subscriber line is spreading and the metallic subscriber line is changed to the optical subscriber line. However, in an area where the optical subscriber line is not spread, an area where the spread of the optical subscriber line is difficult, or a collective housing where the optical subscriber line is not introduced, the metallic subscriber line is used as the information transmission line.

The ADSL is widely used as a faster Internet access means than the ISDN. Since the ADSL is a service using a frequency band with a large transmission loss, the degradation in an electrical signal increases as a terminal separates from a telephone office. Therefore, a problem arises that only the terminal located within a distance of about 6 to 7 km from the telephone office can receive the service. Further, in the ADSL, as indicated by the name, the speed on the upward is asymmetrical to the speed of the downward. Since the main application of the ADSL in each house is to access the website of the Internet, the downward with large communication traffic is set at a high speed. Therefore, the ADSL is unsuitable for a means to improve the communication speed of the upward. As for the voice communication and the multimedia communication using the DSL technology, such as the ADSL, like this, are known by JP, P2006-203876A.

Further, in the DSL, the degradation of the electrical signal becomes large as the terminal separates from the telephone office as mentioned above. The degradation of the electrical signal causes a decrease in the communication speed. A change of the communication speed has a great influence on a radio communication system which performs the communication by radio.

In the radio communication system, many radio base station apparatuses which communicate with radio terminals by radio are installed. The whole radio communication system is required to operate synchronously so that the radio signal which the radio base station apparatus uses in the communication with the radio terminal does not interfere with the radio signal used by other radio base station apparatus.

The radio base station apparatus reproduces a clock from the signal received from the communication apparatus connected with via a cable. As for the communication between the communication apparatus and the radio base station apparatus using the DSL, the communication speed changes in accordance with the distance between the communication apparatus and the radio base station apparatus. Therefore, a frequency of the clock reproduced by the radio base station apparatus changes with the distance between the communication apparatus and a radio base station apparatus. As a result, a problem arises that the network synchronization is not obtained.

### SUMMARY OF THE INVENTION

An object of the invention is to provide a radio communication system and a radio base station apparatus which perform high speed communication speed using a metallic subscriber line and which perform a network synchronization.

To achieve the above object a radio communication system according to the invention includes a plurality of radio base station apparatuses to perform radio communication with a radio terminal, a communication apparatus to be connected to an IP network, and a digital subscriber line to connect the radio base station apparatus and the communication apparatus. The communication apparatus has a 1st transmitter unit which transmits data to the radio base station apparatus with a signal of a 1st time division frame structure created based on a network synchronization clock via the digital subscriber line. The radio base station apparatus includes a clock unit which generates a clock of a predetermined frequency from a signal of a first time division frame structure supplied from the communication apparatus, a radio communication unit performs radio communication with the radio terminal using a signal of a 2nd time division frame structure created based on the clock, and a 2nd transmission unit which transmits the data which was received from the radio terminal by the radio communication unit to the communication apparatus via the digital subscriber line using the signal of the 3rd time division frame structure created based on the clock.

To achieve the above object, a radio base station apparatus according to the invention used in a radio communication system which has a plurality of radio base station apparatuses to perform radio communication with a radio terminal, a communication apparatus to be connected to an IP network, and a digital subscriber line to connect the radio base station apparatus and the communication apparatus. The radio base station apparatus includes a clock unit which generates a clock of a predetermined frequency from a signal of a first time division frame structure supplied from the communication apparatus, a radio communication unit which performs radio communication with the radio terminal using a signal of a 2nd time division frame structure created based on the clock, and a 2nd transmission section which transmits the data received from the radio terminal by the radio communication unit to the communication apparatus via a digital subscriber line using a signal of 3rd time division frame structure created based on the clock.

### BRIEF DESCRIPTION OF THE DRAWINGS

FIG. 1 is a block diagram showing constitution of a radiocommunication system concerning an embodiment of the invention.

FIG. 2 is a block diagram showing construction of a communication apparatus with which the radio communication system concerning the embodiment of the invention is equipped.

FIG. 3 is a block diagram showing construction of a subscriber line interface unit with which the communication apparatus of the radio communication system concerning the embodiment of the invention is equipped.

FIG. 4 is a block diagram showing constitution of a circuit switch and a control unit with which the communication apparatus of the radio communication system concerning the embodiment of the invention is equipped.

FIG. 5 is a block diagram showing constitution of an IP conversion unit with which the communication apparatus of the radio communication system concerning the embodiment of the invention is equipped.

FIG. 6 is a block diagram showing constitution of a packet switch with which the communication apparatus of the radio communication system concerning the embodiment of the invention is equipped.

FIG. 7 is a block diagram showing constitution of the radio base station apparatus which the radio communication system concerning the embodiment of the invention has.

FIG. 8 is a block diagram showing constitution of a clock unit with which the radio base station apparatus of the radio communication system concerning the embodiment of the invention is equipped.

FIG. 9 is a drawing showing a radio frame structure used when performing a radio communication of the data between the radio base station apparatus and the radio terminal of the radio communication system concerning the embodiment of the invention.

FIG. 10 is a drawing showing the radio frame structure transferring the data with the radio communication system and a frame structure used when the data is transmitted on a digital subscriber line concerning the embodiment of the invention.

FIG. 11 is a drawing showing a frame structure used when making data transmit on a PCM highway with which the communication apparatus of the radio communication system concerning the embodiment of the invention is equipped.

### DETAILED DESCRIPTION OF THE INVENTION

Hereinafter, an embodiment of the invention is described with reference to the drawings.

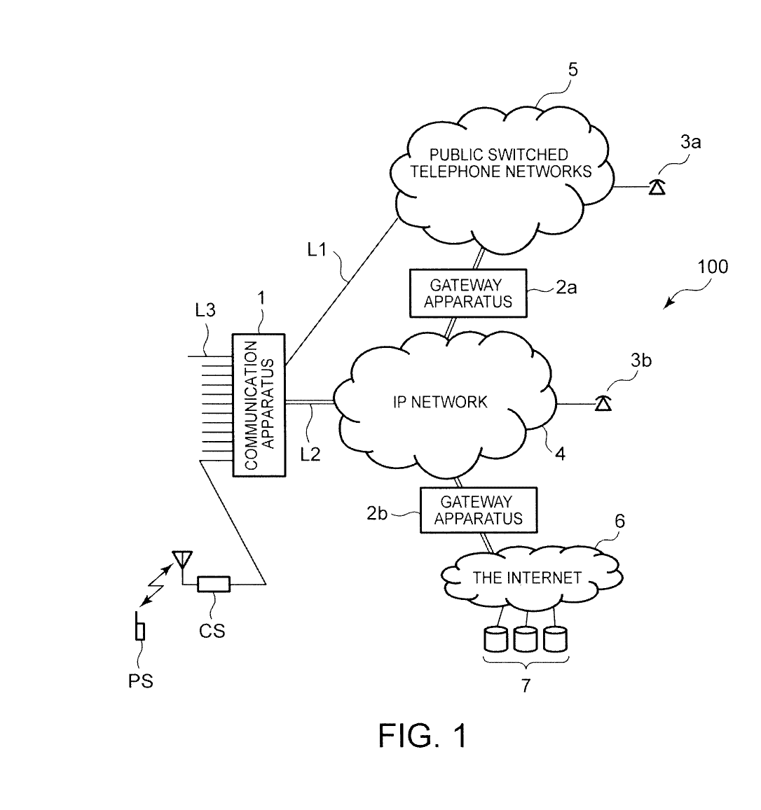

FIG. 1 is a block diagram showing the constitution of a radio communication system 100 of an embodiment. In the radio communication system 100, a radio base station apparatus CS is connected to a communication apparatus 1, and the communication apparatus 1 is connected to an IP network 4 and a public switched telephone network 5. A radio terminal PS is connected with the radio base station apparatus CS, and the radio terminal PS communicates with the IP network 4 and the public switched telephone network 5 via the radio base station apparatus CS and the communication apparatus 1. The radio terminal PS can telephone to an IP telephone terminal 3b connected to the IP network 4 or a telephone terminal 3a connected to the public switched telephone network 5.

An xDSL, such as SHDSL (Single-pair High-speed Digital Subscriber Line) using a metallic subscriber line L3, is used for a connection between the communication apparatus 1 and the radio base station CS. The metallic subscriber line L3 is used as the digital subscriber line L3. Many digital subscriber lines L3 are connected to the communication apparatus 1. One radio base station apparatus CS is shown in FIG. 1, however, each radio base station apparatus CS can be connectable with each digital subscriber line L3. The SHDSL is applied to the digital subscriber line L3 which connects the communication apparatus 1 and the radio base station apparatus CS, thus even if the distance between the communication apparatus 1 and the radio base station apparatus CS, that is, the length of the digital subscriber line L3, is long, the Internet access service can be provided with a faster communication speed than the ISDN, while compared with the case where the ADSL is applied, the communication speed is a little inferior.

In addition to such constitution, the IP network 4 is connected with the Internet via a gateway apparatus 2b, and a plurality of server apparatuses 7 are connected to the Internet 6. Thus, the communication terminal PS also becomes possible to connect the Internet.

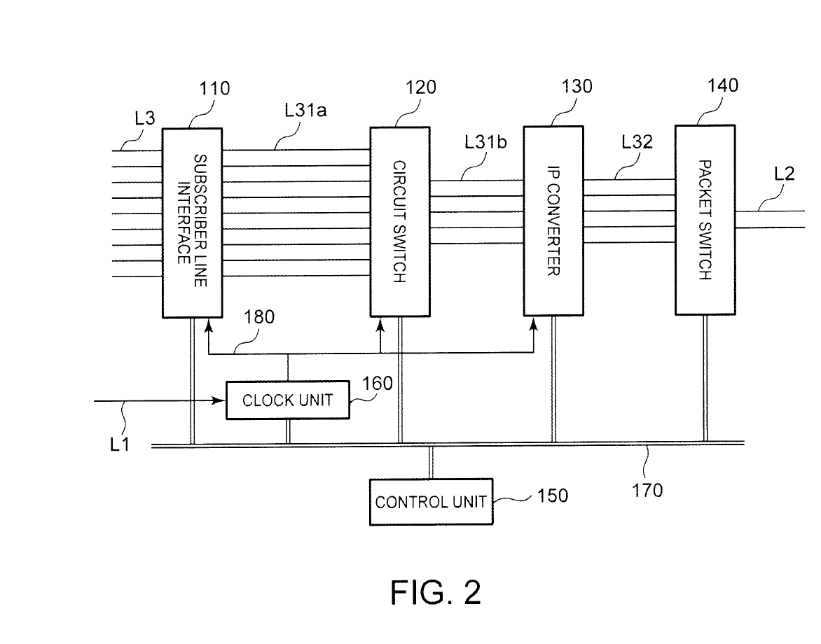

FIG. 2 is a block diagram showing the constitution of the communication apparatus 1 which the radio communication system has. The communication apparatus 1 has a subscriber line interface 110, a circuit switch 120, an IP converter 130, a packet switch 140, a control unit 150 and a clock unit 160.

The digital subscriber line L3 connected with the radio base station apparatus CS is connected to the subscriber line interface 110, and the subscriber line interface 110 and the circuit switch 120 are connected by a PCM highway L31a which transmits PCM data. External data LANs L2 connected with the IP network 4 are connected with the packet switch 140, and the packet switch 140 and the IP converter 130 are connected by the internal data LANs L32. The IP converter 130 and the circuit switch 120 are connected by the PCM highway L31b. The circuit switch 120 is configured to exchange a line between the PCM highway L31a connected with the subscriber line interface 110 and the PCM highway L31b connected with the IP converter 130 and connect them. The number of the PCM highways L31b is smaller than the number of the PCM highways L31a.

The subscriber line interface 110 transmits the data which is transmitted on the digital subscriber line L3 to the PCM highway L31a, or transmits the data which is transmitted on the PCM highway L31a to the digital subscriber line L3. The subscriber line interface 110 is shown by one block in FIG. 2, however, it comprises same number of subscriber line interface units 110a, . . . , 110n as the number of the digital subscriber lines L3 which the communication apparatus 1 accommodates. One digital subscriber line L3 and one PCM highway L31a are connected to one of the subscriber interface unit 110a, and the subscriber unit 110a processes data stream.

The IP converter 130 converts the PCM data which is transmitted on the PCM highway L31a into the IP packet, or converts IP packet which is sent from the packet switch 140 into the PCM data. The IP converter 130 is shown by one block in FIG. 2. However, the IP converter 130 comprises IP conversion units 130a, . . . , 130n of same number as the number of the PCM highways L31b. That is, the IP converter 130 comprises the IP conversion units 130a, . . . , 130n of a number smaller than the number of the digital subscriber lines L3 which the communication apparatus 1 accommodates. Each IP conversion unit 130a is connected to one PCM highway L31a and one internal data LAN L32, and the IP conversion unit 130a performs IP conversion of data stream.

Further, the subscriber line interface 110, the circuit switch 120, the IP converter 130, the packet switch 140, the control unit 150 and the clock unit 160 are mutually connected by a control bus 170. Furthermore, the clock unit 160 connects with the public switched telephone network 5 via a line L1. The clock unit 160 receives the clock provided from the public switched telephone network 5 and supplies the clock to the subscriber line interface 110, the circuit switch 120 and the IP converter 130 via a clock line 180.

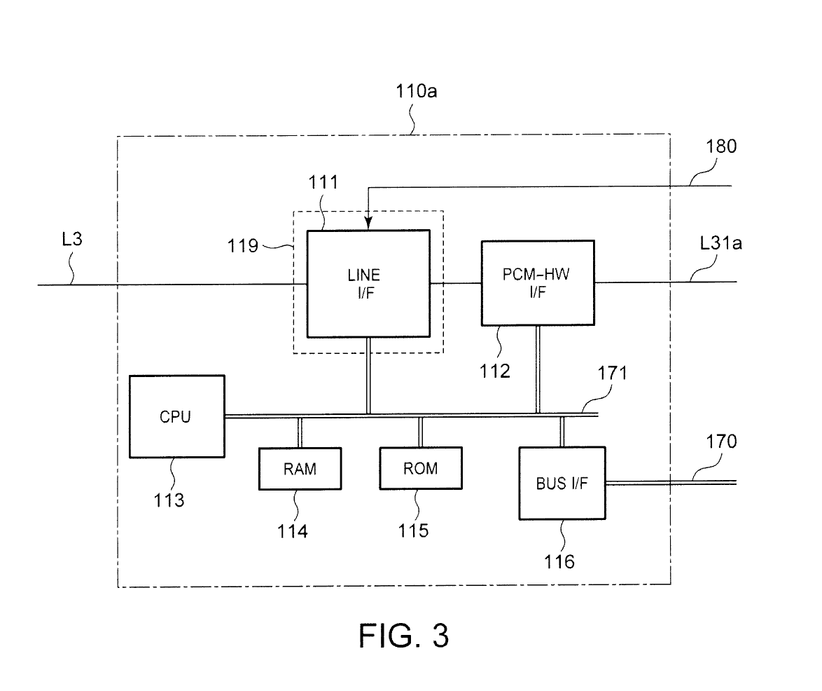

Next, with reference to FIGS. 3 to 6, the constructions of the subscriber line interface unit 110a, the circuit switch 120, the control unit 150, the IP conversion unit 130a and the packet switch 140 which the communication apparatus 1 has are explained.

First, the subscriber line interface 110 is explained. FIG. 3 shows the block diagram of the subscriber line interface unit 110a which is one of the units which constitute the subscriber line interface 110. The subscriber line interface units 110a to 110n are the same structure. The subscriber line interface unit 110a has a line interface 111, a PCM highway interface 112, a CPU 113, a RAM 114, a ROM 115 and a bus interface 116.

One subscriber line L3 in a large number of the subscriber lines L3 which the communication apparatus 1 accommodates and the PCM highway interface 112 are connected to the line interface 111. The clock line 180 is connected to the line interface 111 and the clock outputted from the clock unit 160 is inputted into the line interface 111. The PCM highway L31a connected to the circuit switch 120 is connected to the PCM highway interface 112. Further, the CPU 113, the RAM 114, the ROM 115, the bus interface 116, the line interface 111 and the PCM highway interface 112 are mutually connected by a data bus 171. Furthermore, the bus interface 116 is connected to the control bus 170 which connects with a bus interface 154 with which the control unit 150 mentioned later is equipped.

The line interface 111 extracts the data of a time slot from a signal of a time divisional frame structure sent via the digital subscriber line L3 based on the clock inputted from the clock unit 160 and transmits the data to the PCM highway interface 112. The PCM highway interface 112 inserts the received data to a time slot of a time division frame structure on the PCM highway L31a which is a time division bus.

Further, the line interface 111 transmits a signal of the time division frame structure created based on the clock inputted from the clock unit 160 to the radio base station apparatus CS using the digital subscriber line L3. Thus, the network synchronization clock which synchronizes with the clock provided from the public switched telephone network 5 is supplied to the radio base station apparatus CS. The line interface 111 constitutes a 1st transmitter unit 119.

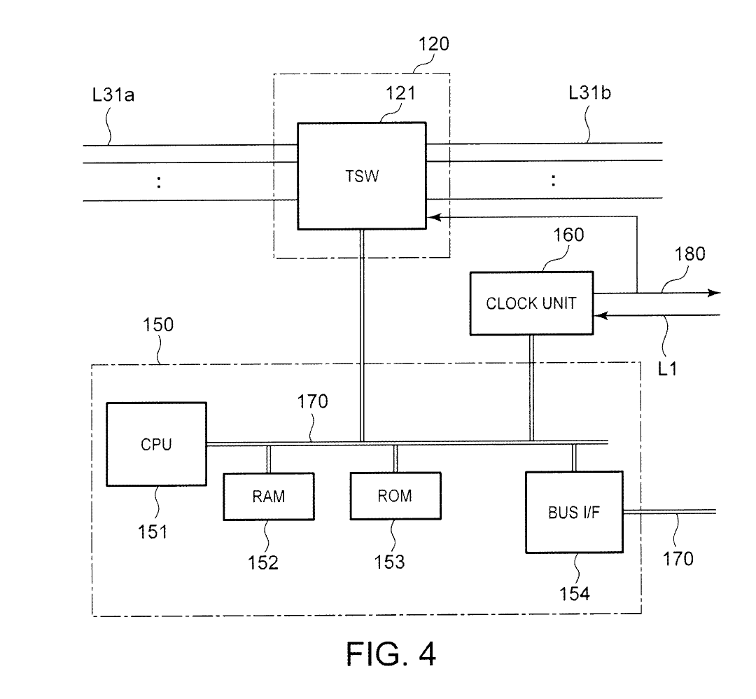

FIG. 4 shows a block diagram of the circuit switch 120 and the control unit 150.

The circuit switch 120 includes a time division switch 121. The PCM highways L31a connected with the PCM highway interfaces 112 of the subscriber line interface 110 and the PCM highways L31b connected with the IP converter 130 are connected to the time division switch 121.

The control unit 150 has a CPU 151, a RAM 152, a ROM 153 and a bus interface 154. The CPU 151, the RAM 152, the ROM 153, the bus interface 154, the time division switch 121 and the clock unit 160 are mutually connected by the control bus 170. Further, the control bus 170 is connected to the subscriber line interface 110, the IP converter 130, and the packet switch 140 via the bus interface 154.

When making a communication path, the time division switch 121 is configured to connect a plurality of the PCM highways L31a connected with the subscriber line interface 110 side and a plurality of the PCM highways L31b connected with the IP converter 130 side in the time division switch 121 based on the clock provided from the clock unit 160 via clock line 180. As mentioned above, the number of PCM highways L31b is smaller than the number of PCM highways L31a.

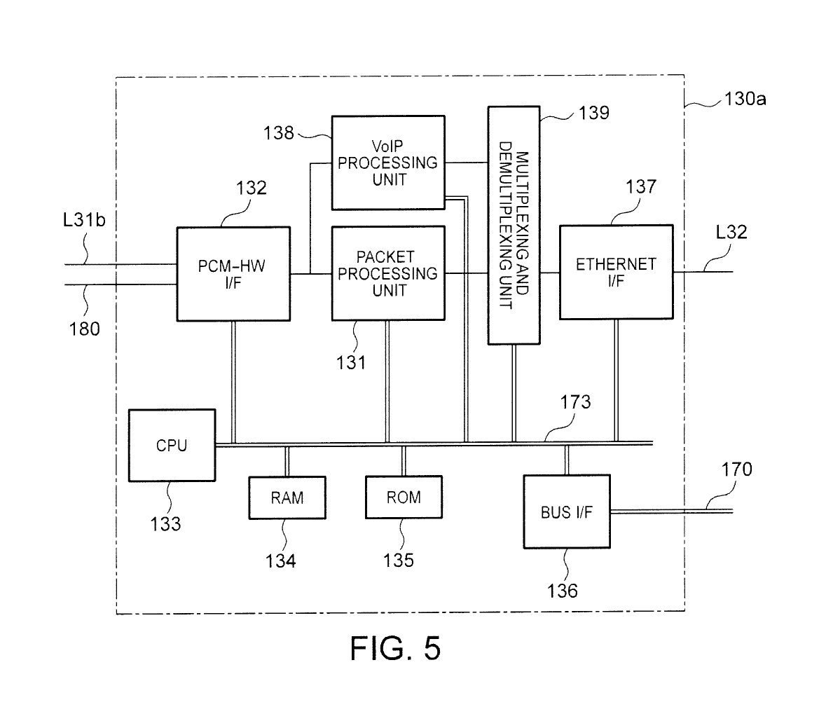

FIG. 5 shows a block diagram of the IP conversion unit 130a which is one of the units which constitute the IP converter 130. The IP conversion units 130a through 130n are the same constitution.

The IP conversion unit 130a includes a packet processing unit 131, a PCM highway interface 132, a CPU 133, a RAM 134, a ROM 135, a bus interface 136, an Ethernet (registered trademark) interface 137, a VoIP processing unit 138, and multiplexing and demultiplexing unit 139.

One PCM highway L31b in PCM highways L31b connected to the circuit switch 120 is connected to the PCM highway interface 132. Further, the clock is inputted into the PCM highway interface 132 via the clock line 180 from the clock part 160. Further, the PCM highway interface 132 is connected to the VoIP processing unit 138 and the packet processing unit 131. The VoIP processing unit 138 and the packet processing unit 131 are further connected to a multiplexing and demultiplexing unit 139, respectively, and the multiplexing and demultiplexing unit 139 is connected to the Ethernet interface 137.

The CPU 133, the RAM 134, the ROM 135, the bus interface 136, the PCM highway interface 132, the packet processing unit 131, the VoIP processing unit 138, the multiplexing and demultiplexing unit 139 and the Ethernet interface 137 are mutually connected by a internal control bus 173. Further, the bus interface 136 is connected with the control bus 170 which connects with the bus interface 154 which the control unit 150 includes.

When receiving the data from the circuit switch 120, the PCM highway interface 132 takes out the data of the time slot from the signal of the time division frame structure on the PCM highway L31 based on the clock inputted from the clock unit 160 via the clock line 180. The PCM highway interface 132 sends the PCM data to the VoIP processing unit 138 and sends the packet data to the packet processing unit 131 among the taken-out data. The packet processing unit 131 converts the packet data into the IP packet with an address, and sends it to the multiplexing and demultiplexing unit 139. The VoIP processing unit 138 converts the PCM data into the IP packet with an address, and sends it to the multiplexing and demultiplexing unit 139. The multiplexing and demultiplexing unit 139 multiplex the IP packet received from the packet processing unit 131 or the VoIP processing unit 138, and sends it to the Ethernet interface 137. The Ethernet interface 137 transmits the multiplexed IP packet to the packet switch 140 via the internal data LAN L32 using the structure of the LAN.

Thus, since all the PCM data sent from the many radio base station apparatuses CS which the communication apparatus 1 accommodates is collected in the IP converter 130 and is converted into the IP packet, a number of the VoIP processing units 138 which convert the PCM data to the IP packet can be reduced as the whole system. In the case that each of radio base station apparatuses CS has the VoIP processing unit, the time ratio that the VoIP processing unit is not used is high in each of the radio base station apparatuses CS. However, since the VoIP processing units are installed collectively to the communication apparatus 1 as a system in the radio communication system of the embodiment, the utilization ratio of VoIP processing unit becomes high.

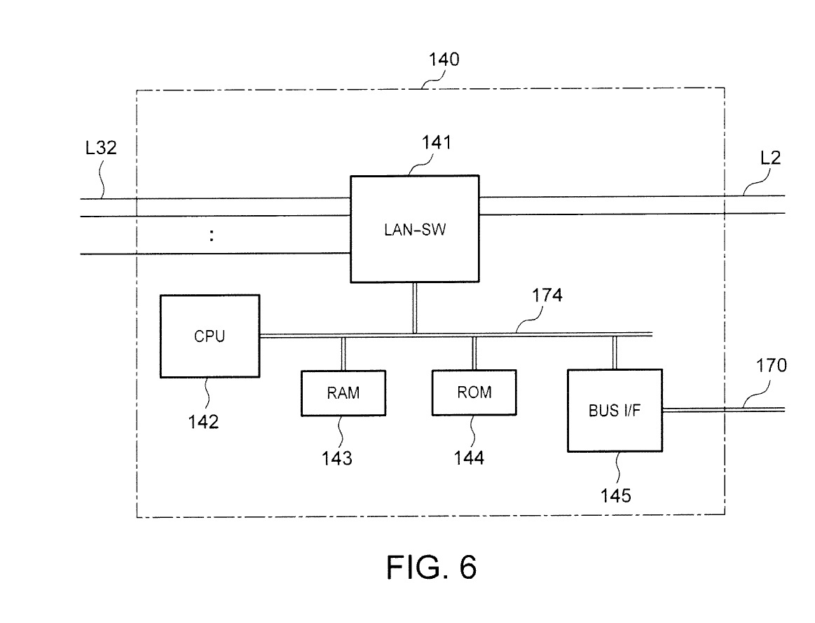

FIG. 6 shows the block diagram of the packet switch 140.

The packet switch 140 includes a LAN switch 141, a CPU 142, a RAM 143, a ROM 144 and a bus interface 145, and these are mutually connected by an internal control bus 174. The LAN switch 141 is connected to the internal data LAN L32 connected to the IP conversion unit 130a which the IP converter 130 has. The LAN switch 141 transmits the IP packet received from these internal data LAN L32 to the address of the IP packet using the cable L2 which connects with the IP network of the exterior of the communication apparatus 1.

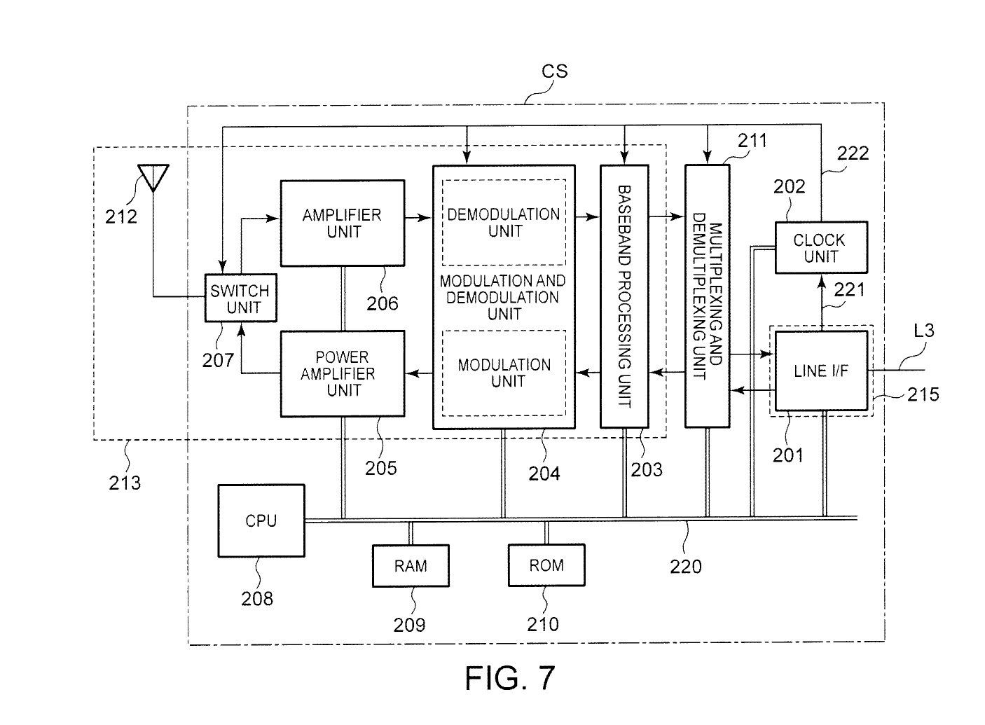

FIG. 7 is a block diagram of the radio base station apparatus CS with which the radio communication system is equipped. The radio base station apparatus CS is provided with a line interface 201, a clock unit 202, a baseband processing unit 203, a modulation and demodulation unit 204, a power amplifier unit 205, an amplifier unit 206, a switching unit 207, a CPU 208, a RAM 209, a ROM 210, and a multiplexing and demultiplexing unit 211. They are mutually connected via an internal control bus 220. The baseband processing unit 203, the modulation and demodulation unit 204, the power amplifier unit 205, the amplifier unit 206, the switching part 207, and an antenna 212 are the basic constitution portions for performing radio communication, and they constitute a radio communication unit 213. The line interface 201 constitutes a 2nd transmitter unit 215, and the clock unit 202 constitutes a clock generation unit. The clock generated by the clock unit 202 is supplied to the switching unit 207, the modulation and demodulation section 204, the baseband processing unit 203, and the multiplexing and demultiplexing unit 211 via the clock line 222.

According to the clock from the clock unit 202, the switching unit 207 changes so that the antenna 212 may be connected with the power amplifier unit 205 or the amplifier unit 206 in accordance with transmission and reception. When the radio base station apparatus CS receives the radio signal modulated with the PCM data or the packet data from the radio terminal PS, the switching unit 207 sends the received radio signal to the amplifier unit 206. The amplifier unit 206 amplifies the received signal and outputs it to the modulation and demodulation unit 204. The demodulation unit of the modulation and demodulation unit 204 demodulates the signal based on the clock from the clock unit 202, and outputs a baseband signal to the baseband processing unit 203. The baseband processing unit 203 takes out the PCM data or the packet data from the baseband signal based on the clock from the clock unit 202, and outputs them to the multiplexing and demultiplexing unit 211. The multiplexing and demultiplexing unit 211 multiplexes the PCM data and the packet data based on the clock inputted via the clock line 222 and sends them to the line interface 201. The line interface 201 transmits the multiplexed data to the communication apparatus 1 via the digital subscriber line L3.

On the contrary, it is as follows when a communication partner of the radio terminal PS, for example, a terminal unit 3b, transmits a signal to the radio terminal PS. The signal from the communication partner reaches the radio base station apparatus CS via the communication apparatus 1, the digital subscriber line L3, etc. and is received by the line interface 201. The received signal is sent to the multiplexing and demultiplexing unit 211, and the PCM data of an audio signal and the packet data are taken out based on the clock generated by the clock unit 202. The taken-out PCM data and packet data are sent to the baseband processing unit 203, and the data is inserted in the time slot of the time division transmission frame which transmits the data to the radio terminal PS on radio based on the clock generated by the clock unit 202, and the baseband signal is generated. The baseband signal is modulated by the modulation unit of the modulation and demodulation unit 204, and is further amplified by the power amplifier unit 205. The amplified signal is transmitted to the radio terminal PS as a radio signal from the antenna 212 via the switching unit 207. The radio terminal PS receives the radio signal, extracts the PCM data and the packet data, and reproduces the audio signal from the PCM data.

The line interface 201 is configured to extract a bit timing component from the signal inputted from the digital subscriber line L3 and output the bit timing component as a clock to the clock unit 202 via the clock line 221. And the clock unit 202 generates a clock using the bit timing component. The clock is supplied to the switching unit 207, the modulation and demodulation unit 204, the baseband processing unit 203, and multiplexing and demultiplexing unit 211.

Thus, the radio base station apparatus CS multiplexes and transmits the packet data and the PCM data to the communication apparatus 1 via the digital subscriber line L3 without converting the PCM data into the IP packet.

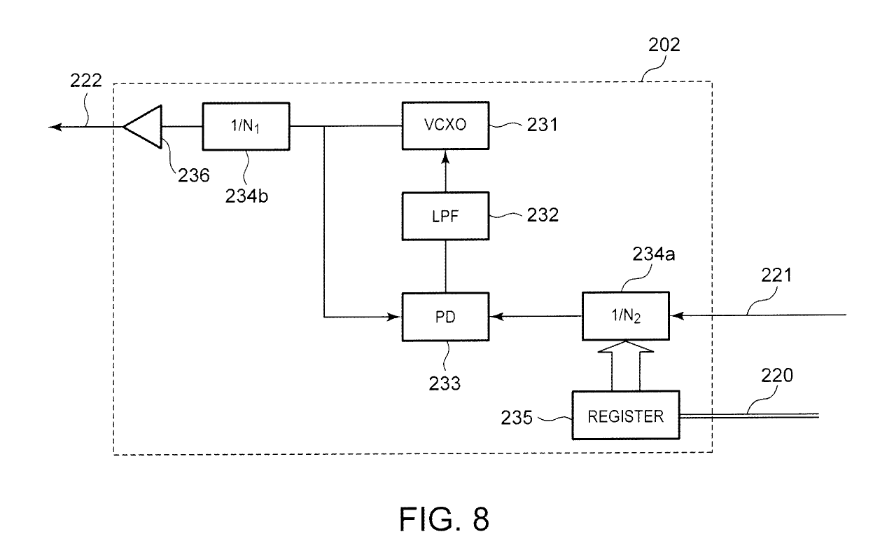

FIG. 8 shows the constitution of the clock unit 202 with which the radio base station apparatus CS is equipped. The clock unit 202 operates by structure of a PLL (Phase-Locked Loop) frequency synthesizer. The clock unit 202 includes a voltage controlled oscillator 231, a low pass filter 232, a phase detector 233, dividers 234a, 234b, register 235 and buffer 236. In this embodiment, the PLL frequency synthesizer shall contain the voltage controlled oscillator 231, the low pass filter 232, the phase discriminator 233, the divider 234a, and also the divider 234b. Thereby, the divider 234b outputs a signal of the clock of a predetermined frequency which the clock unit 202 generates.

The clock which is extracted with the line interface 201 and which is sent from the communication apparatus 1 is inputted into a divider 243a via the clock line 221. A frequency of the clock is divided to 1/N2 by the divider 234a (division ratio is N2). A phase discriminator 233 discriminates the phase difference between a signal outputted from the divider 234a and a signal outputted from the voltage controlled oscillator 231, and outputs a voltage signal in accordance with the phase difference. The low pass filter 232 removes a high frequency component from the voltage signal and compensates a phase. The output of the low pass filter 232 is inputted into the voltage controlled oscillator 231. The voltage controlled oscillator 231 outputs the signal whose phase and frequency correspond with the output of the divider 243a. The frequency of the outputted signal is divided to 1/N1 by the divider 234b (division ratio is N1), and the divided signal is sent to the baseband processing unit 203, the modulation and demodulation unit 204, etc. as the clock via the buffer 236. Here, the dividing numbers N1, N2 of the dividers 234a, 234b can be determined arbitrarily. The dividing number N2 is determined by the CPU 208 which the radio base station apparatus CS has, and is set to the register 235 of the clock unit 202 via the internal control bus 220. The dividing number N1 is fixed to a predetermined fixed number N1. The dividing numbers N1, N2 of the dividers 234a, 234b can be calculated from the frequency of the signal inputted into the clock unit 202 and the frequency of the clock to obtain. For example, in order to obtain a 400 Hz clock, the dividing number N (=N1×N2) which the divided frequency becomes 400 Hz is calculated beforehand and is set up.

The radio base station apparatus CS reproduces the clock from the signal inputted via the digital subscriber line L3 from the communication apparatus 1. If the distance between the radio base station apparatus CS and the communication apparatus 1 becomes long when the DSL is used for the communication between the radio base station apparatus CS and the communication apparatus 1, a signal will deteriorate and communication speed will become slow. Therefore, in the communication system by this embodiment, the communication speed is adjusted so that each communication speed between the communication apparatus 1 and each radio base station apparatus CS via the digital subscriber line L3 may become the same. For example, the communication speed between the communication apparatus land each radio base station apparatus CS is adjusted to the communication speed of the radio base station apparatus CS with the longest distance between the radio base station apparatus CS and the communication apparatus 1 and the slowest communication speed. Thus, each radio base station apparatus CS extracts the clock from the signal inputted from the communication apparatus 1 via the digital subscriber line L3, then each radio base station apparatus CS can reproduce the clock of the same frequency.

In this case, the communication apparatus 1 calculates the dividing number N2 of the divider 234a for the clock unit 202 to generate the clock of 400 Hz based on the frequency of the clock extracted from the signal of this communication speed, and notifies the dividing number N2 to each radio base station apparatus CS. Each radio base station apparatus CS sets the dividing number N2 notified from the communication apparatus 1 to the register 235. Thus, each radio base station apparatus CS generates the clock of the same frequency and the same phase by the clock unit 202. In addition, a setup to the register 235 of the dividing number N2 may be performed at the time when the radio base station apparatus CS is installed, for example.

Thus, the radio base station apparatus CS can obtain the clock common to the network from the signal inputted via the digital subscriber line L3 using the DSL from the communication apparatus 1 by setting up the dividing numbers N1, N2 of the dividers 234a, 234b.

In the above-mentioned embodiment, all the radio base station apparatus CS connected with the communication apparatus 1 communicates with the communication apparatus 1 with the same communication speed. However, the present invention is not restricted to this. The communication apparatus 1 and the radio base station apparatus CS may communicate by the different communication speed in accordance with the distance. In this case, the radio base station apparatus CS measures the frequency of the clock extracted from the signal which is communicated between the communication apparatus 1 and the radio base station apparatus CS, for example. And the CPU 208 of the radio base station apparatus CS may calculate the dividing number N2 of the divider 234a for the clock unit 202 to generate the clock of 400 Hz, and set the dividing number N2 at the register 235. Even if the radio base station apparatus CS is configured thus, each radio base station apparatus CS can obtain the clock common to the network.

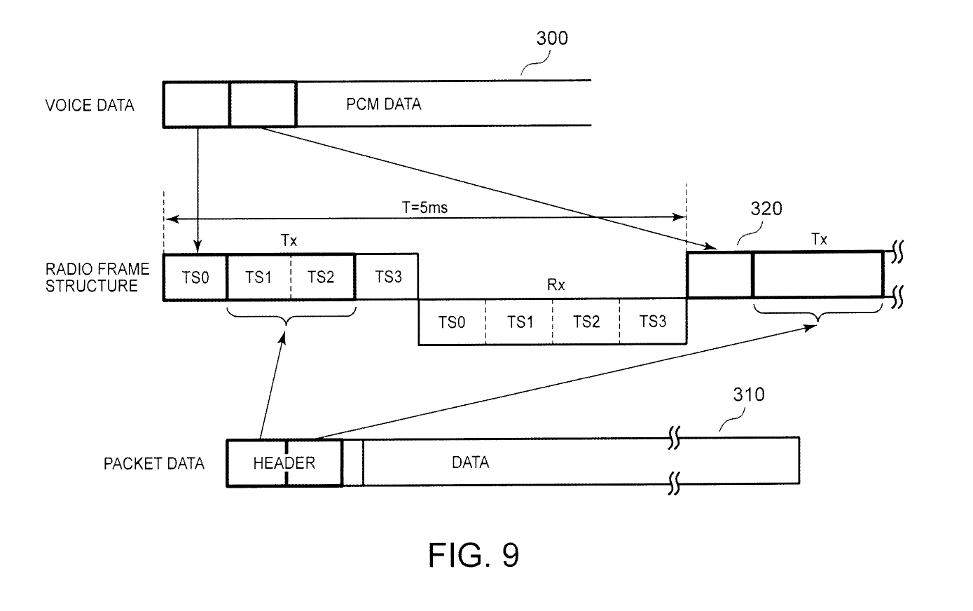

Next, with reference to FIGS. 9 through 11, the frame structure used when transmitting the data in the radio communication system is explained.

First, FIG. 9 shows a radio frame structure which the radio terminal PS uses in the communication with the radio base station apparatus CS.

In FIG. 9, a numeral 300 denotes voice data. The voice data is the PCM data in which a voice signal corresponding to the voice inputted into a microphone (not shown) of the radio terminal PS is modulated by the PCM. A numeral 310 denotes the packet data. The packet data is the packet data inputted from an information terminal (not shown), such as a personal computer connected to the radio terminal PS. Further, a numeral 320 denotes a frame structure used when the radio terminal PS transmits the data to the radio base station apparatus CS by radio. Transmission frame Tx and reception frame Rx are specified alternately in time, and a cycle is 5 ms. The PCM data and the packet data are multiplexed in accordance with the frame structure used when the radio terminal PS transmits the data to the radio base station apparatus CS by radio.

The transmission frame Tx and the reception frame Rx comprise four time slots TS0 to TS3, respectively. For example, when the voice data uses a time slot TS0 and the packet data uses time slots TS1, TS2, the multiplexing and the demultiplexing unit (not shown) of the radio terminal PS divides the voice data and the packet data into the data size which can be transmitted using each time slot, and multiplexes the data by inserting the divided data in the predetermined time slots TS0, TS1 and TS2.

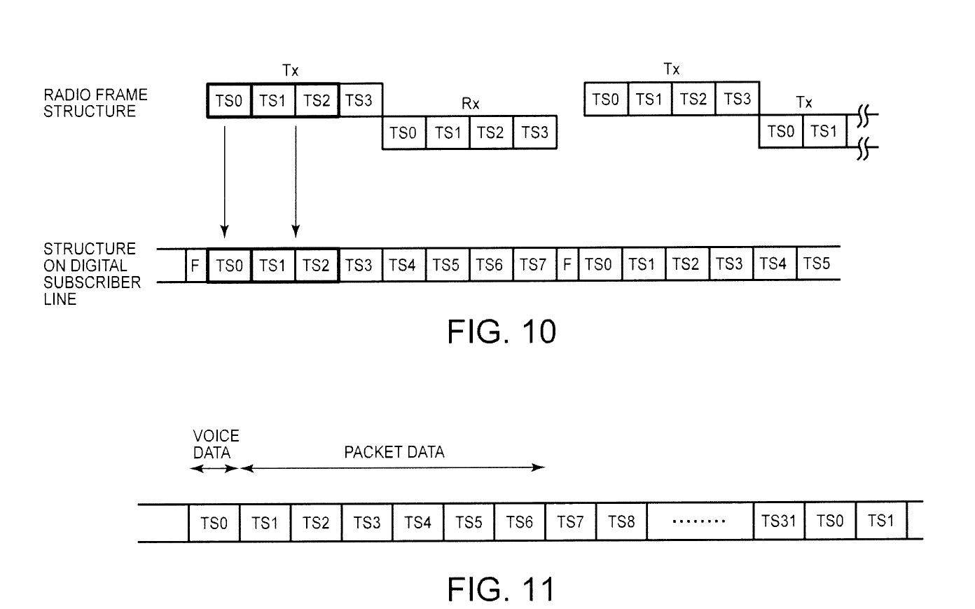

Next, FIG. 10 shows a frame structure of the data transfer used when the radio terminal PS communicates with the radio base station apparatus CS, and a frame structure of the data transfer used when the radio base station apparatus CS transmits the data to the digital subscriber line L3. The data (the data contained in the transmission frame TX which the radio terminal PS transmits) which the radio base station apparatus CS received by radio is taken out based on the clock from the clock unit 202 by the baseband processing unit 203. Further, the taken out data is multiplexed in accordance with the frame structure on the digital subscriber line L3 based on the clock from the clock unit 202 by the multiplexing and demultiplexing unit 211. The multiplexed data is transmitted to the communication apparatus 1 by the line interface 201 via the digital subscriber line L3. The frame structure of the data on the digital subscriber line L3 comprises eight time slots TS0 to TS7 and a frame synchronization bit F which shows a head of the time division frame. For example, when the PCM data uses a time slot TS0 and the packet data uses time slots TS1, TS2, the multiplexing and demultiplexing unit 211 divides the data into the data size which can be transmitted using each time slot, and multiplexes the data by inserting the divided data in the predetermined time slots TS0, TS1 and TS2. That is, the PCM data inserted in the time slot TS0 of the transmission frame TX is inserted in the time slot TS0 of the frame structure on the digital subscriber line L3, and the packet data inserted in the time slots TS1, TS2 of the transmission frame TX is inserted in the time slots TS1, TS2 of the frame structure on the digital subscriber line L3.

Next, FIG. 11 shows a frame structure of the signal transmitted on the PCM highways L31a, L31b with which the communication apparatus is equipped. The frame structure of the signal which the subscriber line interface 110 of the communication apparatus 1 received via the digital subscriber line L3 is changed into the frame structure of the signal which transfers the data on the PCM highway L31a by the PCM highway interface 112. A time division frame of the PCM highway L31a includes 32 time slots TS0 to TS31.

The line interface 111 which the subscriber line interface 110 has takes out the data transmitted using the time division frame on the digital subscriber line shown in FIG. 10 based on the clock sent from the clock unit 160, and sends the data to the PCM highway interface 112. The PCM highway interface 112 transmits the data, which is sent from the line interface 111, using the time division frame on the PCM highway L31a shown in FIG. 11. Here, in the frame structure on the PCM highway L31a, the time slot TS0 is used only for the voice data, and the time slots TS1 to TS6 are used only for the packet data, for example.

Next, it is explained how the frame structures shown in FIGS. 9 through 11 are used.

First, the case where the radio terminal PS calls the IP telephone terminal 3b connected to the IP network 4 is explained. When the radio terminal PS performs a dialing operation of calling the IP telephone terminal 3b, the radio base station apparatus CS receives a sign of the calling and the dial information containing a telephone number of called party from the radio terminal PS. The dial information is separated by the multiplexing and demultiplexing unit 211, and is outputted to the CPU 208. The CPU 208 changes the dial information in accordance with a LAPD (Link Access Procedure on the D-channel) protocol etc., and sends the created signal of the LAPD protocol to the multiplexing and demultiplexing unit 211 again. The multiplexing and demultiplexing unit 211 insert the signal of the LAPD protocol in the time slot TS7 used for signaling in the frame structure on the digital subscriber line L3 shown in FIG. 10.

On the other hand, in the communication apparatus 1, when the subscriber line interface 110 receives the signal of the LAPD protocol, the line interface 111 extracts the signal of the LAPD protocol on the time slot TS7. The extracted LAPD protocol signal is relayed by the CPU 113 and transmitted to the CPU 151 which the control unit 150 has, via the data bus 171, the bus interface 116 and the control bus 170. The CPU 151 communicates with a database of the telephone subscribers which is not illustrated in this embodiment, and the database sounds a ring tone of the IP telephone terminal 3b. When the IP telephone terminal 3b of the called party performs an incoming operation, such as taking up a handset which is not illustrated, a speech path between the radio terminal PS and the IP telephone terminal 3b is formed.

Next, the case where a telephone call is performed between the radio terminal PS and the IP telephone terminal 3b is explained. The sound inputted into the microphone of the radio terminal PS is changed into the PCM data, and is transmitted to the radio base station apparatus CS using the time slot TS0 of the radio frame shown in FIG. 9 every 8 bits. In the radio base station apparatus CS, the radio signal is decoded, and the PCM data is taken out by the baseband processing unit 203 and is sent to the multiplexing and demultiplexing unit 211. The multiplexing and demultiplexing unit 211 inserts the PCM data into the time slot TS0 of the time division frame structure on the digital subscriber line L3 shown in FIG. 10, and outputs the PCM data to the line interface 201.

The line interface 201 transmits the data to the communication apparatus 1 with the time division frame structure on the digital subscriber line L3 shown in FIG. 10.

On the other hand, in the communication apparatus 1, the line interface 111 which the subscriber line interface 110 has extracts the PCM data from the time slot TS0 of the time division frame on the digital subscriber line L3 and transmits the PCM data to PCM highway interface 112. The PCM highway interface 112 inserts the extracted PCM data to the time slot TS0 of the division frame on the PCM highway L31a shown in FIG. 11. Hereafter, the voice inputted into the radio terminal PS can be transmitted to the IP telephone terminal 3b which is a called partner by the same processing as the explanation shown in FIG. 4 through FIG. 7. Further, the voice from the called partner is transmitted to the radio terminal PS from the IP telephone terminal 3b and is received by the radio terminal PS through a course contrary to the transmission.

Thus, according to the radio communication system of the invention, even if the communication apparatus 1 and the radio base station apparatus CS communicate using the DSL, each radio base station apparatus CS can generates the clock which synchronized mutually. Therefore, according to the invention, the radio communication system and the radio base station apparatus which perform the high speed communication using the metallic subscriber lines and are capable of the network synchronization can be provided.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A radio communication system, comprising:
a plurality of radio base station apparatuses to perform radio communication with a radio terminal;
a communication apparatus to be connected to IP (Internet Protocol) network; and
a digital subscriber line to connect the radio base station apparatus and the communication apparatus;
wherein
the communication apparatus includes:
a 1st transmitter unit which transmits data to the radio base station apparatus with a signal of a 1st time division frame structure created based on a network synchronization clock via the digital subscriber line;
the radio base station apparatus includes:
a clock unit generates a clock of a predetermined frequency from the signal of the first time division frame structure supplied from the communication apparatus;
a radio communication unit performs radio communication with the radio terminal using a signal of a 2nd time division frame structure created based on the clock; and
a 2nd transmitter unit transmits the data received from the radio terminal by the radio communication unit to the communication apparatus via the digital subscriber line using a signal of a 3rd time division frame structure created based on the clock.

2. The radio communication system according to claim 1, wherein the clock unit includes a PLL (Phase-Locked Loop) frequency synthesizer.

3. The radio communication system according to claim 2, wherein the PLL frequency synthesizer has a programmable divider which divides a frequency of an input signal, and a dividing number of the programmable divider is determined so that the PLL frequency synthesizer generates a clock of a predetermined frequency.

4. The radio communication system according to claim 3, wherein the dividing number of the programmable divider is determined in accordance with the communication speed between the communication apparatus and the radio base station apparatus so that the PLL frequency synthesizer generates the clock of the predetermined frequency.

5. The radio communication system according to claim 1, wherein the radio communication unit receives PCM (Pulse Code Modulation) data from the radio terminal.

6. The radio communication system according to claim 1, wherein the radio communication unit receives PCM (Pulse Code Modulation) data and IP packet data from the radio terminal.

7. A radio base station apparatus used in a radio communication system which has a plurality of radio base station apparatuses to perform radio communication with a radio terminal, a communication apparatus to be connected to IP (Internet Protocol) network, and a digital subscriber line to connect the radio base station apparatus and the communication apparatus, the radio base station apparatus comprising:
a clock unit to generate a clock of a predetermined frequency from a signal of a first time division frame structure supplied from the communication apparatus;
a radio communication unit to perform radio communication with the radio terminal using a signal of a 2nd time division frame structure created based on the clock; and
a transmitter unit to transmit the data received from the radio terminal by the radio communication units to the communication apparatus via the digital subscriber line using a signal of a 3rd time division frame structure created based on the clock.

8. The radio base station apparatus according to claim 7, wherein the clock unit has a PLL (Phase-Locked Loop) frequency synthesizer.

9. The radio base station apparatus according to claim 8, wherein the PLL frequency synthesizer has a programmable divider which divides a frequency of an input signal, and a dividing number of the programmable divider is determined so that the PLL frequency synthesizer generates a clock of a predetermined frequency.

10. The radio base station apparatus according to claim 9, wherein the dividing number of the programmable divider is determined in accordance with the communication speed between the communication apparatus and the radio base station apparatus so that the PLL frequency synthesizer generates the clock of the predetermined frequency.

11. The radio base station apparatus according to claim 7, wherein the radio communication unit receives PCM (Pulse Code Modulation) data and IP packet data from the radio terminal, and the transmission unit transmits the PCM data and the IP packet data to the communication apparatus via the digital subscriber line using the signal of the 3rd time division frame structure.
